(19) United States
(12) Patent Application Publication
(10) Pub. No.: US 2021/0347622 A1
(43) Pub. Date: Nov. 11, 2021

(54) Hands Free, Self-Venting Oil Filler Funnel

(71) Applicant: Larry Hein, Portland, OR (US)

(72) Inventor: Larry Dein Hein, Portland, OR (US)

(73) Assignee: Larry Hein, Portland, OR (US)

(21) Appl. No.: 17/300,236

(22) Filed: Apr. 22, 2021

Related U.S. Application Data
(60) Provisional application No. 63/101,377, filed on Apr. 27, 2020.

(51) Int. Cl. B67C 11/02

(52) U.S. Cl. CPC B67C 11/02; B67C 2011/027

(57) ABSTRACT

A hands-free, self-venting device for adding oil to the crankcase of a diesel engine mounted in a semi-truck comprises a funnel having a self-venting passage open at both ends, primarily conical in shape and increasingly diminishing in shape wherein a diameter of the inlet is greater that a diameter of a throat, which is greater than a diameter of the outlet. With an upper body section to receive oil, a middle transition throat which allows oil to be poured freely and also allows air to be vented from the crankcase of a diesel engine simultaneously, without obstruction. The oil flow is redirected to a lower section that mounts easily with just a firm push of the lower body section into the oil fill tube of a diesel engine, sealing tightly enough to create a seal that will prevent leakage.

### CROSS REFERENCE

This application claims priority to U.S. Patent Application No. 63/101,377 filed on Apr. 26, 2020, the entire disclosure of which is incorporated herein by reference.

### FIELD OF THE INVENTION

The present disclosure describes embodiments of a new and improved oil filler funnel related to a class of funnels designed for adding oil to diesel engines of any configuration, more particularly to a class of funnels used for adding oil to diesel engines mounted in semi-trucks.

### BACKGROUND OF THE INVENTION

Mechanics around the world have encountered the same problems while attempting to add oil to the crankcase of a diesel engine mounted in a semi-truck. Specifically, irrespective of the engine configuration, most diesel engines have an oddly positioned oil fill tube which can be difficult to reach. More particularly, on most diesel engines, the oil fill tube rises upward and then outward from the engine block, thus terminating with its opening at an angle of somewhere between 40° and 60°, depending on the manufacturers specifications. Thus, spills and leaks are very common while adding oil to any diesel engine, and proper clean up where the spill or leak has occurred can be time consuming, and at times very expensive. Most spills and leaks are caused by overfilling the funnel, due in part to poor ventilation and/or improper funnel design. Typically oil for diesel engines is sold in one gallon jugs that weigh a little over six pounds. The mechanic must give his full attention to his task or the mechanic could easily make a mess of the job. For example, while servicing a diesel engine mounted in a semi-truck the mechanic must reach out and over the front wheel and various other engine apparatus to reach the oil fill tube. The mechanic must then place and hold a funnel into the oddly angled oil fill tube opening with one hand, while reaching even higher with the other hand to pour the oil. While holding the gallon jug of oil which is heavy and hard to control, the mechanic begins pouring. Meanwhile, the funnel fails to stay in place, it wobbles loosely and its intake point doesn't face upward, making it very difficult to pour oil into. Now it begins to leak at its base where there is no seal between the funnel and oil fill tube. The mechanic then tries bracing the funnel so the mechanic can use both hands on the heavy and sometimes slippery oil jug. As the mechanic pours the oil, the funnel fills quickly, but drains slowly. The mechanic must stop pouring the oil or the oil will overfill, and valuable time begins to waste away.

In the prior art there have been many funnels proposed, none of which have been as simply designed, as effective, nor as economical to manufacture.

For example, (1) U.S. Pat. No. 3,537,623 discloses an oil filler spout that fits over an oil can, which then acts as a funnel; (2) U.S. Pat. No. 4,494,585 discloses a funnel having a system for ventilation consisting of a primary vent and an auxiliary vent/siphon for the release of air or gas from a container being filled; (3) U.S. Pat. No. 5,787,944 discloses a self-venting funnel which includes a hollow member having inner and outer walls, two ends and a through passage; (4) U.S. Pat. No. 6,568,440 B1 discloses a telescoping funnel that is attached to an engine oil fill tube with latches; and (5) U.S. Pat. No. 7,017,626 B2 discloses an oil filler neck assembly which includes a hinged lid and a lock.

To address and eliminate these problems, the present disclosure describes various embodiments of an oil filler funnel designed with a radical new concept that will replace conventional funnels used for adding oil to a diesel engine mounted in a semi-truck.

### SUMMARY OF THE INVENTION

It is an object of the present disclosure to provide a clean, safe and efficient means for adding oil to diesel engines mounted in semi-trucks.

Another object of the present disclosure is to provide an oil filler funnel that fits tightly into an oil fill tube of diesel engines mounted in semi-trucks, which would create a stable mounting point for the funnel, aiding in maintaining an upright position. Eliminating leakage around the connection of the funnel with the oil fill tube of a diesel engine.

And still another object of the present disclosure is to provide an oil filler funnel for adding oil to diesel engines mounted in semi-trucks that is self-venting. With a firm push it seals tightly allowing the funnel to “self-vent” the air being displaced from the engines crankcase, both speeding up the process and to prevent overfilling the funnel.

Yet another object of the present disclosure is to provide an oil filler funnel for adding oil to a diesel engine mounted in a semi-truck that will free both hands for use to manipulate a hard to handle, one gallon jug of oil for the ease of pouring oil freely and true into the opening at the fill end of the funnel.

Furthermore, another object of the present disclosure is to provide an efficient funnel that is easily and economically manufactured for distribution.

The objects of the present disclosure are achieved in part by a sturdy attachment that results in a seal created by simply applying a firm push of the enlarged drain opening of the oil filler funnel into the oil fill tube of a diesel engine.

The objects of the present disclosure are also achieved in part by an enlarged transition point (throat) in a funnel which allows oil to be poured freely into the upper body portion, while air is being vented from the engines crankcase simultaneously. The airflow moves in the opposite direction, without obstruction.

One form of the oil filler funnel of the present disclosure comprises (a) a conical upper body section having an inlet pour opening, (b) a conical lower body section having an outlet drain opening, and (c) a middle transition throat in fluid communication with the inlet pour opening and the outlet drain opening to define a self-venting fluid passage extending from inlet pour opening through the middle transition throat to the outlet drain opening.

A configuration of the self-venting passage includes (i) a diameter of the inlet pour opening being greater than a diameter of the middle transition throat, (ii) a diameter of the middle transition throat being greater than a diameter of the outlet drain opening and (iii) a transition angle between a longitudinal axis of lower body section relative to an axis of symmetry of the upper body section being slanted for facilitating a flow of air into the outlet drain opening through the middle transition throat and the inlet pour opening to an atmosphere as motor oil is poured into the inlet pour opening through middle transition throat and the outlet drain opening into a diesel engine.

The foregoing embodiments and other embodiments of the inventions of the present disclosure as well as various structures and advantages of the inventions of the present disclosure will become further apparent from the following detailed description of various embodiments of the inventions of the present disclosure read in conjunction with the accompanying drawings. The detailed description and drawings are merely illustrative of the inventions of the present disclosure rather than limiting, the scope of the inventions of the present disclosure being defined by the appended claims and equivalents thereof.

### BRIEF DESCRIPTION OF THE DRAWINGS

FIG. 1 is a perspective view of an exemplary embodiment of an oil filler funnel in accordance with the present disclosure.

FIG. 2 is a top view of the oil filler funnel of FIG. 1 showing a middle transition throat of the oil filler funnel of FIG. 1 in accordance with the present disclosure.

FIG. 3 is a side view of the oil filler funnel of FIG. 1 snugly fitted into an oil fill tube of a diesel engine, showing the sturdy mount where a tight seal is created by friction with the drain opening.

FIG. 4 is a top view of the oil filler funnel of FIG. 1 showing exemplary measurements of the middle transition throat and of the outlet drain opening of the lower body section.

FIG. 5 is a side view of the present disclosure showing of the oil filler funnel of FIG. 1 showing exemplary measurements of the upper body section and the lower body section.

FIG. 6 is a perspective view of the oil filler funnel of FIG. 1 being exemplarily utilized to self-vent as oil is poured into a diesel engine.

### DETAILED DESCRIPTION OF THE DRAWINGS

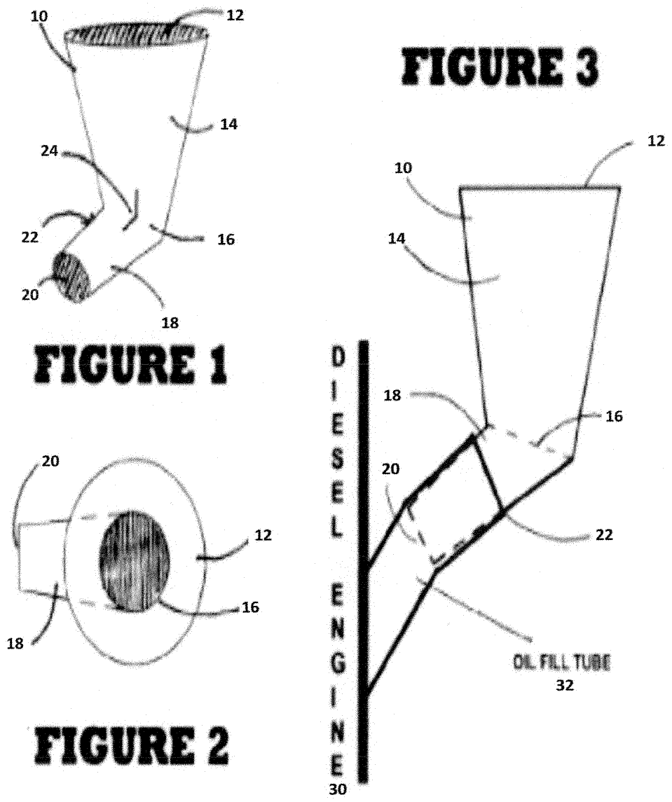

To facilitate an understanding of various aspects of the present disclosure, the following description of FIGS. 1-6 teaches various embodiments of an oil filler funnel of the present disclosure. From this description, those having ordinary skill in the art will appreciate how to apply the various aspects of the present disclosure for making and using additional embodiments of oil filler funnels of the present disclosure.

Referring to FIG. 1, a perspective view of an oil filler funnel 10 in one embodiment of the present disclosure shows oil filler funnel 10 having a self-venting fluid passage open at both ends, conical in shape and increasingly diminishing in size from the proximal inlet end of oil filler funnel 10 to the distal drain end of oil filler funnel 10. The self-venting fluid passage is defined by an upper body section 14 having an inlet pour opening 12 for receiving oil and a middle transition throat 16 connecting upper body section 14 to a lower body section 108 to redirect the oil to an outlet drain opening 20 for draining oil. In practice, a seal plane 22 along lower body section 18 proximal to the outlet drain opening 20 will create a tight seal between the oil filler funnel 10 and the oil fill tube via friction.

Referring to FIG. 2, a top view of an oil filler funnel 10 showing inlet pour opening 12 for receiving oil and the middle transition throat 16 for redirecting oil flow through the outlet drain opening 20 of lower body section 18 for draining oil.

Referring to FIG. 3, a side view of oil filler funnel 10 snugly fitted into an oil fill tube 32 of a diesel engine 30 shows the lower body section 18 friction fitted within oil fill tube 32 whereby a tight seal is created with friction between the oil filler funnel 10 and the oil fill tube 32 along seal plane 22 of lower body section 18.

Friction is created by firmly pushing the lower body section 18 of oil filler funnel 10 into the oil fill tube 32 of diesel engine 30 until a tight seal is created which prevents leaking. Also creating a sturdy mounting point of the lower body section 18 and the opening of the oil fill tube 32 of a diesel engine 30 which adds stability to the present disclosure allowing the mechanic the use of both hands.

Referring back to FIG. 1, in practice, the dimensions of oil filler funnel 10 are designed to meet the dimensions and angle of an oil fill tube of the various diesel engine configurations. Also in practice, (1) a ratio of a diameter of the inlet pour opening 12 to a diameter of the middle transition throat 16 is greater than 1.00 (preferably 1.40-1.60), (2) a ratio of a diameter of the middle transition throat 16 to a diameter of the outlet drain opening 20 is greater than 1.00 (preferably 1.40-1.60) and (3) a slanting transition angle 24 between a longitudinal axis of lower body section 18 relative to an axis of symmetry the upper body section 14 is greater than 50° (preferably 55°-65°.

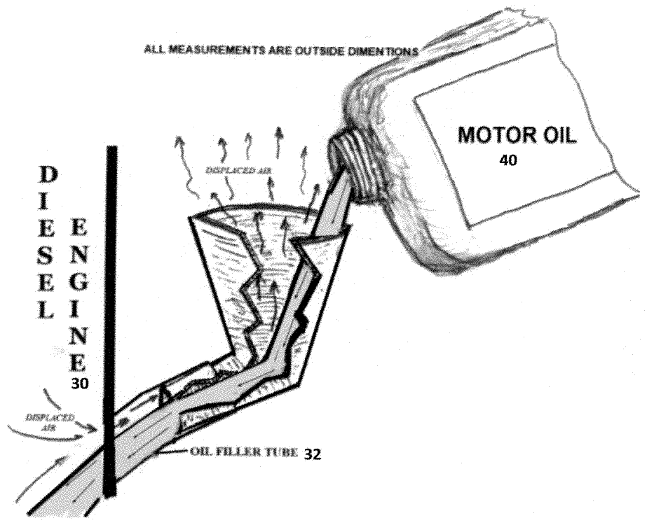

Referring to FIG. 4, a top view oil filler funnel 10 shows (1) an exemplary diameter of the inlet pour opening 12 of upper body section 14 for receiving oil to be 95 mm, (2) an exemplary diameter of the middle transition throat 16 for redirecting oil flow to be 50 mm, (3) an exemplary minimum length of a top halve of lower body section 18 to be 70 mm, and (4) an exemplary diameter of the outlet drain opening 20 to be 35 mm.

Referring to FIG. 5, a side view oil filler funnel 10 shows (1) an exemplary diameter of the inlet pour opening 12 of upper body section 14 for receiving oil to be 95 mm, (2) an exemplary minimum length of a front halve of upper body section 14 to be 110 mm, (3) an exemplary maximum length of a back halve of upper body section 14 to be 130 mm, (4) an exemplary maximum length of a back halve of lower body section 18 to be 90 mm, (5) a transition angle 24 (FIG. 1) between a longitudinal axis of lower body section 18 relative to an axis of symmetry the upper body section 14 is 60° and (6) a material thickness of upper body section 14 and lower body section 18 being 1.5 mm.

In practice, oil filler funnel 10 may be manufactured utilizing any technique as known to one skilled in the art of the present disclosure. In one embodiment, injection molding with a durable yet inexpensive polypropylene thermoplastic is utilized to create oil filler funnel 10, such as, for example, with the measurements of FIG. 4 and FIG. 5.

Referring to FIG. 6, one skilled in the art will appreciate how the dimensions of oil filler funnel facilitate a self-venting of displaced air within diesel engine 30 into outlet drain opening 20 through middle transition throat 16 and inlet pour opening 12 to atmosphere as motor oil 40 is poured into inlet pour opening 12 through middle transition throat 16 and outlet drain opening 20 into diesel engine 30 without the use of mechanic hands.

Having described preferred and exemplary embodiments of novel and inventive oil filler funnel (which embodiments are intended to be illustrative and not limiting), it is noted that modifications and variations can be made by persons having ordinary skill in the art in light of the teachings provided herein, including the FIGS. 1-6. It is therefore to be understood that changes can be made in/to the preferred and exemplary embodiments of the present disclosure which are within the scope of the embodiments disclosed herein.

1. An oil filler funnel, comprising:
a conical upper body section having an inlet pour opening;
a conical lower body section having an outlet drain opening;
a middle transition throat in fluid communication with the inlet pour opening and the outlet drain opening to define a self-venting fluid passage extending from the inlet pour opening through the middle transition throat to the outlet drain opening; and
wherein a configuration of the self-venting fluid passage includes (i) a diameter of the inlet pour opening being greater than a diameter of the middle transition throat, (ii) a diameter of the middle transition throat being greater than a diameter of the outlet drain opening and (iii) a transition angle between a longitudinal axis of the lower body section relative to an axis of symmetry of the upper body section being slanted for facilitating a flow of air into the outlet drain opening through the middle transition throat and the inlet pour opening to an atmosphere as motor oil is poured into the inlet pour opening through middle transition throat and the outlet drain opening into a diesel engine.

2. The oil filler funnel of claim 1, wherein a ratio of the diameter of the inlet pour opening to the diameter of the middle transition throat is greater than 1.40.

3. The oil filler funnel of claim 1, wherein a ratio of the diameter of the middle transition throat to the diameter of the outlet drain opening is greater than 1.40.

4. The oil filler funnel of claim 1, wherein the transition angle between the longitudinal axis of lower body section relative to the axis of symmetry of the upper body section is slanted at an angle greater than 50°.

5. The oil filler funnel of claim 1, wherein the conical lower body section is operable to be friction fitted within an oil fill tube of the diesel engine as the motor oil is poured into the inlet pour opening through the middle transition throat and the outlet drain opening into the diesel engine.
